(19) United States
(12) Patent Application Publication
(10) Pub. No.: US 2020/0264023 A1
(43) Pub. Date: Aug. 20, 2020

(54) AIR FLOW RATE MEASURING DEVICE AND AIR FLOW RATE MEASURING SYSTEM

(71) Applicant: DENSO CORPORATION, Kariya-city (JP)

(72) Inventor: Noboru KITAHARA, Kariya-city, Aichi-pref. (JP)

(21) Appl. No.: 16/866,680

(22) Filed: May 5, 2020

Related U.S. Application Data
(63) Continuation of application No. PCT/JP2018/037343, filed on Oct. 5, 2018.

(30) Foreign Application Priority Data
Nov. 8, 2017 (JP) 2017-215761

(51) Int. Cl. G01F 1/696; G01F 1/69

(52) U.S. Cl. CPC G01F 1/696; G01F 1/69

(57) ABSTRACT

An air flow meter includes a processing unit measuring an air flow rate based on an output signal of a sensing unit placed in environment where air flows and outputting the air flow rate to an ECU. The processing unit includes an intake air flow rate computation unit acquiring an air flow rate based on the output signal, and an argument acquisition unit and a pulsation correction value computation unit acquiring pulsation correction information for correcting a pulsation error based on the acquired air flow rate. The processing unit also includes an air flow meter output unit outputting pulsation correction information in addition to the air flow rate to the ECU.

### CROSS REFERENCE TO RELATED APPLICATION

The present application is a continuation application of International Patent Application No. PCT/JP2018/037343 filed on Oct. 5, 2018, which designated the U.S. and claims the benefit of priority from Japanese Patent Application No. 2017-215761 filed on Nov. 8, 2017. The entire disclosures of all of the above applications are incorporated herein by reference.

### TECHNICAL FIELD

The present disclosure relates to an air flow rate measuring device and an air flow rate measuring system.

### BACKGROUND

Conventionally, a control device of an internal combustion engine is generally provided at a position apart from an air flow sensor in a vehicle. The control device computes an intake air flow rate on the basis of an output value of the air flow sensor.

### SUMMARY

According to an aspect of the present disclosure, an air flow rate measuring device is configured to measure an air flow rate based on an output signal of a sensing unit, which is placed in an environment where air flows, and to output the air flow rate to an electronic device. The air flow rate measuring device comprises a flow rate acquisition unit configured to acquire the air flow rate based on the output signal

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a schematic configuration of an air flow rate measuring system in a first embodiment;

FIG. 2 is a diagram illustrating a schematic configuration of a combustion system in the first embodiment;

FIG. 3 is a block diagram illustrating a schematic configuration of an air flow meter and an ECU in the first embodiment;

FIG. 4 is a block diagram illustrating a schematic configuration of an air flow meter and an ECU in a second embodiment;

FIG. 5 is a block diagram illustrating a schematic configuration of an air flow meter and an ECU in a third embodiment;

FIG. 6 is a diagram illustrating the relation between flow rate and time in the third embodiment;

FIG. 7 is a block diagram illustrating a schematic configuration of an air flow meter and an ECU in a fourth embodiment;

FIG. 8 is a block diagram illustrating a schematic configuration of an air flow meter and an ECU in a fifth embodiment;

FIG. 9 is a map illustrating a correction factor in the fifth embodiment;

FIG. 10 is a diagram illustrating pulsation rate and pulsation error in the fifth embodiment;

FIG. 11 is a diagram illustrating timings of outputs and corrections in the fifth embodiment;

FIG. 12 is a block diagram illustrating a schematic configuration of an air flow meter and an ECU in a sixth embodiment;

FIG. 13 is a diagram illustrating timings of output and correction in the sixth embodiment;

FIG. 14 is a block diagram illustrating a schematic configuration of an air flow meter and an ECU in a seventh embodiment;

FIG. 15 is a block diagram illustrating a schematic configuration of an air flow meter and an ECU in an eighth embodiment;

FIG. 16 is a block diagram illustrating a schematic configuration of an air flow meter and an ECU in a ninth embodiment;

FIG. 17 is a block diagram illustrating a schematic configuration of an air flow meter and an ECU in a tenth embodiment;

FIG. 18 is a block diagram illustrating a schematic configuration of an air flow meter and an ECU in an eleventh embodiment; and

FIG. 19 is a diagram illustrating output patterns of the present disclosure.

### DETAILED DESCRIPTION

As follows, examples of the present disclosure will be described.

According to an assumable example, a control device of an internal combustion engine is provided at a position apart from an air flow sensor in a vehicle. The control device computes an intake air flow rate on the basis of an output value of the air flow sensor.

According to an example, the control device includes a pulsation amplitude ratio computing unit that computes pulsation amplitude ratio from pulsation amplitude amount and average air flow rate of an intake air flow rate, and a pulsation frequency computing unit that computes pulsation frequency caused by rotational speed of an engine. The control device may further include a pulsation error computing unit that computes a pulsation error by using the pulsation amplitude ratio computing unit and the pulsation frequency computing unit and corrects an intake air flow rate on the basis of a pulsation error correction amount computed by the pulsation error computing unit.

In this example, the control device may be required to sufficiently sample an output signal of an air flow sensor so that the waveform of pulsation can be captured in order to accurately grasp information such as pulsation amplitude ratio. Consequently, concern may arise in the control device that the load of communication with the air flow sensor increases.

According to an example of the present disclosure, an air flow rate measuring device is configured to measure an air flow rate based on an output signal of a sensing unit, which is placed in an environment where air flows, and to output the air flow rate to an electronic device The air flow rate measuring device comprises a flow rate acquisition unit configured to acquire the air flow rate based on the output signal The air flow rate measuring device further comprises a correction information acquisition unit configured to acquire pulsation correction information for correcting a pulsation error, which is an error of the air flow rate caused by pulsation of air, based on the air flow rate acquired by the flow rate acquisition unit The air flow rate measuring device further comprises an output unit configured to output the pulsation correction information in addition to the air flow rate to the electronic device.

According to this example, the air flow rate measuring device may enable to suppress increase in communication load due to correction of a pulsation error.

In the following, with reference to the drawings, multiple embodiments for carrying out the present disclosure will be described. In each of the embodiments, there is a case that the same reference numeral is designated to a part corresponding to a matter described in a foregoing embodiment and repetitive description will not be given. In each of the embodiments, in the case where only a part of the configuration is described, for the other part of the configuration, another embodiment described before may be referred to and applied.

### First Embodiment

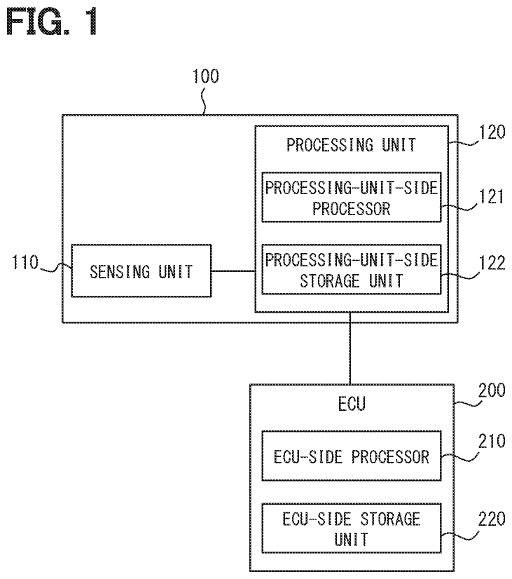

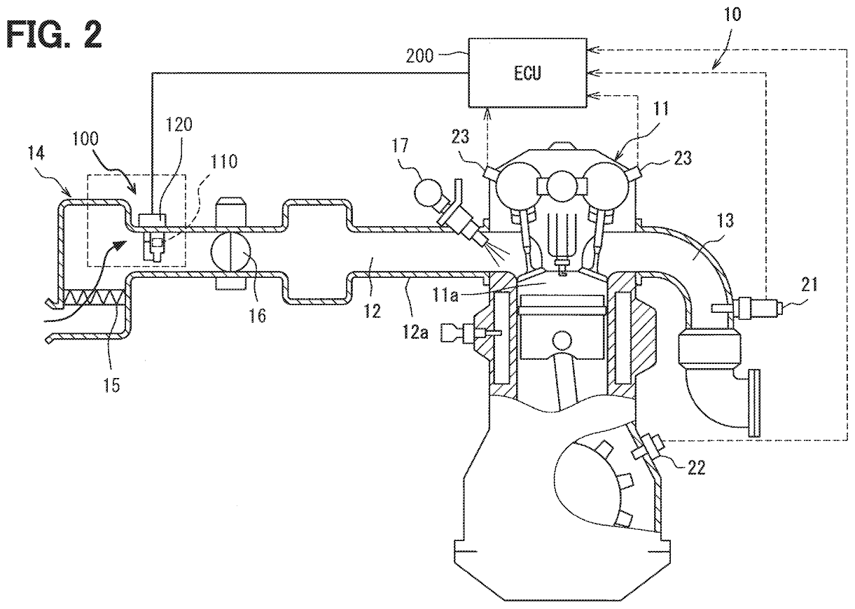

With reference to FIGS. 1, 2, and 3, an air flow meter 100 and an ECU (Electronic Control Unit) 200 of a first embodiment will be described. The air flow meter 100 includes a processing unit 120 that is an air flow rate measuring device. The air flow meter 100 is configured to communicate with the ECU 200. Therefore, in other words, the air flow rate measuring system includes the processing unit 120 and the ECU 200. In the first embodiment, as illustrated in FIG. 2, an example of applying the air flow meter 100 and the ECU 200 to a combustion system 10 is employed. The ECU 200 corresponds to an electronic device.

The combustion system 10 illustrated in FIG. 2 includes an internal combustion engine 11 such as a diesel engine, an intake passage 12, an exhaust passage 13, an air cleaner 14, the air flow meter 100, the ECU 200, and the like. The internal combustion engine 11 is mounted in, for example, a vehicle. The combustion system 10 also includes a throttle valve 16, an injector 17, an air-fuel ratio sensor 21, a crank angle sensor 22, and a cam angle sensor 23.

The air flow meter 100 is provided to the intake passage 12 and has a function of measuring physical amounts such as flow rate, temperature, and humidity of intake air supplied to the internal combustion engine 11. In other words, the air flow meter 100 is a physical amount measuring device whose measurement object is an intake air that is fluid. The intake air is air supplied to a combustion chamber 11a of the internal combustion engine 11 and corresponds to gas. The intake air may also be referred to as an intake.

The air flow meter 100 is attached to an intake pipe 12a as a component of the intake passage 12 on the downstream side of the air cleaner 14. The air cleaner 14 includes an element 15 eliminating a foreign matter mixed in the intake air so that the intake air cleaned by the air cleaner 14 reaches the air flow meter 100. The element 15 is made by, for example, a filter medium such as a non-woven fabric of synthetic fiber or filter paper. The air flow meter 100 will be described in detail later.

The air flow meter 100 (processing unit 120) and the ECU 200 are connected to each other via a signal line and are configured to communicate with each other. For communication between the processing unit 120 and the ECU 200, for example, a communication protocol configured to send signals of two channels in one way from the processing unit 120 to the ECU 200 by a single signal line may be employed. Consequently, the processing unit 120 is configured to output a detection signal and pulsation correction information which will be described later to the ECU 200 via a single signal line. That is, the processing unit 120 is configured to output the detection signal and the pulsation correction information at the same time. It is noted that, the communication between the processing unit 120 and the ECU 200 is not limited to the above.

The ECU 200 is a control device performing operation control of the combustion system 10. As illustrated in FIG. 1, the ECU 200 includes a computer including an ECU-side processor 210, an ECU-side storage unit 220, and an input/output interface.

The ECU-side storage unit 220 includes a non-transitory tangible storage medium that non-temporarily stores a program and data which are to be read by the ECU-side processor 210 and a volatile memory temporarily storing data. That is, the ECU-side storage unit 220 is a storage medium such as a RAM and ROM. In other words, the ECU-side storage unit 220 is embodied with a semiconductor memory, a magnetic disk, or the like.

In the ECU 200, for example, a program for performing an operation control of the combustion system 10 is stored in the ECU-side storage unit 220 and the program is executed by the ECU-side processor 210. While the ECU-side processor 210 executes the program, the ECU 200 performs engine controls such as control of the opening of the throttle valve 16 and control of a fuel injection amount of the injector 17 by using results of measurement of the air flow meter 100 and the like. Consequently, the ECU 200 may also be referred to as an engine control device and the combustion system 10 may also be referred to as an engine control system.

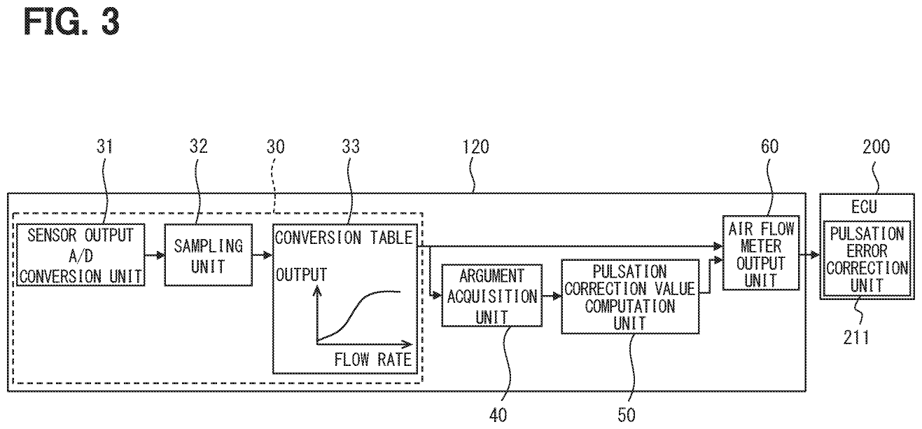

As illustrated in FIG. 3, the ECU 200 includes a pulsation error correction unit 211 correcting a pulsation error of an air flow rate as a measurement result by the air flow meter 100. In other words, the ECU 200 includes the pulsation error correction unit 211 as a function block. The pulsation error correction unit 211 will be described in detail later. The air flow rate as a measurement result may also be referred to as a detection signal according to the air flow rate. Further, the air flow rate is a flow rate of intake air in the intake passage 12.

The air flow meter 100 is one of multiple measuring units included in the combustion system 10, and the multiple measuring units including the air flow meter 100 are electrically connected to the ECU 200. As the measuring units, the air-fuel ratio sensor 21, the crank angle sensor 22, the cam angle sensor 23, and the like may be mentioned. The sensors 21 to 23 output detection signals to the ECU 200. The air-fuel ratio sensor 21 is provided to an exhaust system of the internal combustion engine 11 and detects an air-fuel ratio of exhaust flowing in the exhaust passage 13. The crank angle sensor 22 is attached to, for example, a cylinder block and detects the rotation angle of the crankshaft. The cam angle sensor 23 is attached to, for example, a cylinder head and detects the rotation angle of the camshaft. The ECU 200 acquires the engine rotational speed by using the detection signals of the crank angle sensor 22 and the cam angle sensor 23.

As illustrated in FIG. 1, the air flow mater 100 includes a sensing unit 110 outputting an output signal according to the air flow rate and the processing unit 120 measuring the air flow rate on the basis of the output signal from the sensing unit 110. The output signal may also be referred to as a flow rate signal.

As disclosed in Japanese Unexamined PATENT Application Publication No. 2016-109625 and the like, for example, the air flow meter 100 is placed in the intake passage 12 in a state where the air flow meter 100 is attached to a passage formation member. Specifically, the sensing unit 110 is placed in a sub-bypass passage by being attached to the passage formation member in which a bypass passage (sub air passage) and a sub-bypass passage (sub-sub air passage) through which a part of intake flowing inside (main air passage) of the intake passage 12 passes are formed. It is noted that, the present disclosure is not limited to the above. The sensing unit 110 may be placed directly in the main air passage. As described above, the sensing unit 110 is provided so as to be in contact with intake air in the environment where the intake air flows. That is, the sensing unit 110 is placed in the environment where air flows.

The sensing unit 110 is electrically connected to the processing unit 120 and outputs an output signal according to the air flow rate of the intake air in the bypass flow passage to the processing unit 120. The sensing unit 110 is a thermal-type sensor element having a heating element resistor, a temperature measuring resistor, or the like and may also be referred to as a flow rate detecting unit. The embodiment employs an example that the bypass flow passage has a through flow passage through which intake air passes and a branch flow passage branched from the through flow passage, and the sensing unit 110 is provided to the branch flow passage.

The processing unit 120 includes, like the ECU 200, a computer including a processing-unit-side processor 121, a processing-unit-side storage unit 122, and an input/output interface and is electrically connected to the ECU 200. The processing-unit-side storage unit 122 includes a non-transitory tangible storage medium non-temporarily storing a program and data which are to be read by the processing-unit-side processor 121 and a volatile memory temporarily storing data. That is, an example of the processing-unit-side storage unit 122 is a storage medium such as a RAM or ROM. In other words, the processing-unit-side storage unit 122 is embodied with a semiconductor memory, a magnetic disk or the like.

In the processing unit 120, a program for measuring air flow rate, a program for acquiring pulsation correction information for correcting a pulsation error, and the like are stored in the processing-unit-side storage unit 122, and the program is executed by the processing-unit-side processor 121. That is, in the processing unit 120, the processing-unit-side processor 121 executes the program stored in the processing-unit-side storage unit 122 to perform various operations, thereby performing measurement of air flow rate, acquisition of pulsation correction information, and the like and outputs a detection signal corresponding to the measured air flow rate and the pulsation correction information to the ECU 200. In other words, the processing unit 120 acquires the air flow rate on the basis of the output signal.

In the intake air flowing in the intake passage 12, pulsation including back flow is caused by reciprocating motion of a piston or the like in the internal combustion engine 11. In other words, the pulsation is pulsation of air or intake pulsation. Consequently, the detection signal of the sensing unit 110 includes an error from true air flow rate, that is, a pulsation error due to the influence of the intake pulsation. Particularly, when a throttle valve is operated to the full open side, the sensing unit 110 becomes susceptible to the influence of the intake pulsation.

The true air flow rate is an air flow rate which is not influenced by the intake pulsation. The pulsation error is the difference between an uncorrected air flow rate acquired by an output signal and a true air flow rate. That is, the pulsation error corresponds to the difference between the air flow rate acquired by converting the output value by using an output air flow rate conversion table 33 and the true air flow rate. In other words, the uncorrected air flow rate acquired from the output signal is an air flow rate influenced by the intake pulsation or an air flow rate before correction. Therefore, a correction value which makes the air flow rate before correction closer to the true air flow can be acquired when the pulsation error is known.

Referring to FIG. 3, the processing unit 120 will be described in detail. The processing unit 120 embodies multiple functions when the processing-unit-side processor 121 executes a program. That is, as illustrated in FIG. 3, In other words, the processing unit 120 includes, as multiple function blocks, an intake air flow rate computation unit 30, an argument acquisition unit 40, a pulsation correction value computation unit 50, and an air flow meter output unit 60.

The intake air flow rate computation unit 30 corresponds to a flow rate acquisition unit which acquires an air flow rate on the basis of an output signal of the sensing unit 110. The intake air flow rate computation unit 30 includes a sensor output A/D convestion unit 31, a sampling unit 32, and the conversion table 33. The processing-unit-side processor 121 A/D converts an output signal output from the sensing unit 110 by the sensor output A/D convestion unit 31. The processing-unit-side processor 121 samples the A/D converted output signal by the sampling unit 32 and converts the output signal to an air flow rate (detection signal) by the conversion table 33. In short, the conversion table 33 is an output air flow rate conversion table. That is, the conversion table 33 includes a preliminarily stored air flow rate corresponding to the output signal (voltage value) sampled by the sampling unit 32.

The argument acquisition unit 40 and the pulsation correction value computation unit 50 correspond to a correction information acquisition unit acquiring pulsation correction information for correcting a pulsation error. In the first embodiment, as an example of pulsation correction information, a correction value is employed. It is noted that, the present disclosure is not limited to the correction value but, as will be described later, an argument may also be employed as the pulsation correction information.

The argument acquisition unit 40 acquires an argument for computing (acquiring) a correction value used for correcting a pulsation error. That is, the processing unit 120 acquires, by the argument acquisition unit 40, an argument for computing a correction value on the basis of a detection signal acquired by the intake air flow rate computation unit 30. In other words, the argument acquisition unit 40 captures the waveform of a detection signal from the detection signal and acquires an argument for computing the correction value, that is, an argument for acquiring the pulsation error. Therefore, an argument is a value correlated with a pulsation error.

The pulsation correction value computation unit 50 performs a computing process by using the argument acquired by the argument acquisition unit 40, thereby acquiring a correction value. That is, the processing unit 120 acquires, in the pulsation correction value computation unit 50, a correction value correlated with the argument by using the argument acquired by the argument acquisition unit 40. In other words, the processing unit 120 predicts the pulsation error correlated with the argument and acquires a correction value for eliminating the pulsation error. Further, the processing unit 120 acquires a correction value for making an air flow rate before correction closer to a true air flow rate by using the argument acquired by the argument acquisition unit 40.

As described above, the air flow meter 100 is placed in the intake passage 12 in a state where the sensing unit 110 is attached to the passage formation member. Therefore, depending on the influence of the shape of the passage formation member and the like, the pulsation error may not only increase as the argument becomes larger and but also decrease as the argument becomes larger. Similarly, the pulsation error may not only decrease as the argument becomes smaller but also increase as the argument becomes smaller.

Consequently, there is a case that the relation between an argument and a correction value cannot be expressed by a function. Therefore, the processing unit 120 is preferable since an accurate correction value can be acquired by using a map in which an argument and a correction value are related in the pulsation correction value computation unit 50. As described above, the processing unit 120 acquires pulsation correction information (in this case, a correction value) for correcting a pulsation error on the basis of the air flow rate acquired by the intake air flow rate computation unit 30.

The map in which multiple arguments and correction values correlated with the arguments are associated is stored in the processing-unit-side storage unit 122 or the like. Each of the correction values in the map is a value acquired for each argument in the case of performing an experiment or simulation using a real machine while changing the value of the argument.

The processing unit 120 may, in the pulsation correction value computation unit 50, predict a pulsation error by using a map in which an argument and a pulsation error are associated and acquire a correction value from the predicted pulsation error. The map in which multiple arguments and pulsation errors correlated with the arguments are associated is stored in the processing-unit-side storage unit 122 or the like. Each of the pulsation errors in the map is a value acquired for each argument in the case of performing an experiment or simulation using a real machine while changing the value of the argument. This point is similar also in the following embodiments.

In some cases, the relation between an argument and a correction value may be expressed by a function in a case such that the sensing unit 110 is placed directly in the main air passage. In this case, the processing unit 120 may compute a correction value by using the function. As described above, the processing unit 120 does not have to include a map to compute a correction value by using a function, so that the capacity of the processing-unit-side storage unit 122 can be decreased. This point is similar also in the following embodiments. That is, in the following embodiments, a correction value may be acquired by using a function in place of a map.

The air flow meter output unit 60 corresponds to an output unit of outputting pulsation correction information in addition to the air flow rate to the ECU 200. That is, the processing unit 120 outputs, by the air flow meter output unit 60, an air flow rate before correction converted by the conversion table 33 and a correction value as the pulsation correction information acquired by the pulsation correction value computation unit 50 to the ECU 200 via a signal line. In the first embodiment, since the communication protocol as described above is employed, the air flow rate before correction and the correction value can be output to the ECU 200 simultaneously via a single signal line.

As described above, the processing unit 120 outputs a correction value as the pulsation correction information. Consequently, the ECU 200 does not have to perform a process for acquiring a correction value from an argument. Therefore, the processing unit 120 is enabled to reduce the process load of the ECU 200.

Returning to the description of the ECU 200, the pulsation error correction unit 211 and the like will be described. The ECU 200 is configured so that an air flow rate before correction and a correction value output from the processing unit 120 are acquired. The air flow rate before correction corresponds to an air flow rate output from the processing unit 120.

The pulsation error correction unit 211 corrects the acquired air flow rate on the basis of the acquired correction value. That is, the ECU-side processor 210 corrects the air flow rate so as to eliminate a pulsation error by using the correction value in the pulsation error correction unit 211. In other words, the pulsation error correction unit 211 corrects the air flow rate influenced by the intake pulsation so as to be closer to the real air flow rate. For example, the pulsation error correction unit 211 may make the air flow rate influenced by the intake pulsation closer to the true air flow rate by adding or subtracting the correction value to/from the acquired air flow rate. It is noted that, the present disclosure is not limited to the above. It is sufficient to correct the air flow rate so that the pulsation error is eliminated by using the correction value.

The function embodied with the processing unit 120 may be embodied with hardware or software different from the above-described one or combination of the hardware and the software. The processing unit 120 may communicate with, for example, another control device such as the ECU 200, and the other control device may execute part or all of the process. In the case where the processing unit 120 is embodied with an electronic circuit, it may be embodied with a digital circuit or an analog circuit including a number of logic circuits.

With reference to a comparative example, the effect of the processing unit 120 and the air flow rate measuring system will be described. In the comparative example, although the processing unit of the air flow meter outputs an air flow rate, pulsation correction information such as a correction value is not output. In the comparative example, the ECU acquires a correction value from an air flow rate.

The ECU in the comparative example has to acquire an argument by capturing the waveform of an air flow rate influenced by the intake pulsation in order to acquire a correction value from the air flow rate. That is, the ECU has to sample the air flow rate acquired by the processing unit at sufficiently high speed to capture the waveform of the air flow rate influenced by the intake pulsation.

Since the ECU, which does not correct a pulsation error, does not have to acquire the correction value, the ECU need not to capture the waveform of the air flow rate. Therefore, it is sufficient for the ECU to perform sampling, for example, to an extent that an average value of air flow rates is acquired. That is, the ECU may sample at a sampling interval slower than that of the ECU of the comparative example.

Since the number of sampling times of the ECU of the comparative example increases to correct the pulsation error as described above, the load of the communication with the processing unit becomes larger than that in the case where a pulsation correction is not performed.

In contrast, the processing unit 120 outputs a correction value for correcting a pulsation error in addition to an air flow rate to the ECU 200, so that the ECU 200 does not have to sample the air flow rate to correct the pulsation error. Therefore, the processing unit 120 enables to suppress increase in the communication load and the process load between the processing unit 120 and the ECU 200 to correct the pulsation error. That is, the processing unit 120 enables to make the ECU 200 acquire a correction value only by performing sampling to an extent that, for example, an average value of the air flow rate can be acquired.

Since the air flow rate measuring system includes the processing unit 120 and the ECU 200, similar effects can be produced. Further, the ECU 200 acquires the pulsation correction information output from the processing unit 120, so that the ECU 200 need not to acquire a pulsation correction state on the basis of the air flow rate. Consequently, the ECU 200 enables to correct a pulsation error while suppressing increase in the process load.

Since the processing unit 120 outputs a correction value, the ECU 200 enables to acquire information (correction value) for correcting a pulsation error even at a sampling interval slower than that of the ECU of the comparative example. Therefore, the ECU 200 enables to perform pulsation correction even at a sampling interval slower than that of the ECU of the comparative example. In other words, while decreasing the number of times of communication with the processing unit 120 more than that in the ECU of the comparative example, the ECU 200 enables to perform the pulsation correction. Further, the ECU 200 enables to perform the pulsation correction at a sampling interval similar to that of an ECU which does not perform the pulsation correction, that is, by the number of times of communication with the processing unit 120. In the present disclosure, since the processing unit 120 outputs the air flow rate and the correction value at the same time, even when the ECU 200 performs communication with the processing unit 120 at an interval slower than that of the ECU of the comparative example, the air flow rate and the correction value can be acquired, and a pulsation error can be corrected.

The embodiment of the present disclosure has been described above. It is noted that, the present disclosure is not limited to the foregoing embodiment but can be variously modified without departing from the gist of the present disclosure. Hereinbelow, as other embodiments of the present disclosure, second to eleventh embodiments will be described. The second to eleventh embodiments may be carried out singularly or may be properly combined and carried out. The present disclosure is not limited to combinations described in the embodiments but may be executed in various combinations.

### Second Embodiment

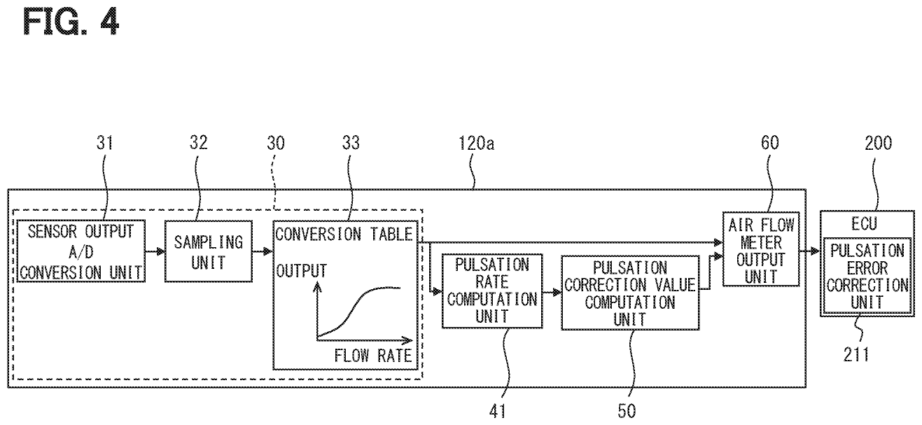

Referring to FIG. 4, an air flow meter of the second embodiment will be described. The air flow meter of the second embodiment is different from the foregoing embodiment with respect to the configuration of a processing unit 120a. In more detail, as illustrated in FIG. 4, the processing unit 120a is different from the processing unit 120 with respect to the point that a pulsation rate computation unit 41 is provided as an example of the argument acquisition unit 40.

In the second embodiment, the different points from the processing unit 120 in the processing unit 120a will be mainly described. In the second embodiment, the same reference numerals are designated to parts similar to those in the foregoing embodiment. Therefore, a component having the same reference numeral as that in the foregoing embodiment may be applied with reference to the foregoing embodiment.

The pulsation rate computation unit 41 acquires a pulsation rate in pulsation waveform of an intake as an argument for computing a correction value used for correcting a pulsation error. That is, the processing unit 120a acquires, in the pulsation rate computation unit 41, a pulsation rate for computing a correction value on the basis of a detection signal acquired by the intake air flow rate computation unit 30. In other words, in the pulsation rate computation unit 41, the waveform of a detection signal is captured from the detection signal and a pulsation rate for computing a correction value, that is, a pulsation rate for acquiring a pulsation error is acquired. Therefore, the pulsation rate is a value correlated with a pulsation error.

The pulsation rate computation unit 41 computes a pulsation rate by using, for example, pulsation amplitude of air flow rate and average air flow rate. In the present disclosure, computation may be replaced by a word such as acquisition or prediction.

The processing unit 120a computes an average air flow rate by using a detection signal acquired by the intake air flow rate computation unit 30. As the average air flow rate, an average air flow rate in a measurement period may be computed by using integration average or an average air flow rate may be computed by using an average of a pulsation minimum value as the minimum value of air flow rates in a measurement period and a pulsation maximum value as the maximum value of the air flow rates in the measurement period.

Further, the processing unit 120a may compute an average air flow rate without using the pulsation minimum value whose detection accuracy is lower than that of the maximum value of the air flow rate or the pulsation minimum value and some air flow rates around the pulsation minimum value. As will be described later, the processing unit 120a computes a pulsation amplitude from the average air flow rate and the pulsation maximum value. Therefore, the processing unit 120a enables to compute a pulsation amplitude on which the influence of the pulsation minimum value is reduced by computing the average air flow rate without using the pulsation minimum value. In other words, the computation accuracy of the pulsation amplitude of the processing unit 120a can be improved by, at the time of computing a pulsation amplitude, computing a pulsation amplitude by using an average air amount and a pulsation maximum value whose detection accuracy is relatively high without using a pulsation minimum value whose detection accuracy is low. The average air amount may also be referred to as an average flow rate.

The processing unit 120a computes a pulsation amplitude by using a detection signal acquired by the intake air flow rate computation unit 30. The processing unit 120a computes a pulsation amplitude from the average air flow rate and the pulsation maximum value acquired as described above by using the detection signal acquired by the intake air flow rate computation unit 30. The processing unit 120a computes a pulsation amplitude of the air flow rate by, for example, acquiring the difference between the pulsation maximum value and the average air amount. That is, pulsation amplitude=pulsation maximum value−average air flow rate. In such a manner, the processing unit 120a acquires a half amplitude of the air flow rate, not a total amplitude of the air flow rate. This is to reduce the influence of the pulsation minimum value whose detection accuracy is relatively low as described above.

For example, the processing unit 120a samples detection signals acquired by the intake air flow rate computation unit 30 and sets the interval between two upper-side extreme values of sampling values as the measurement period (computation period) of the average air flow rate and the pulsation maximum value. The upper-side extreme value is a value of a point at which the detection signal changes from rise to fall. The larger the number of samples, the more accurate average air flow rate and pulsation maximum value can be computed.

The pulsation rate computation unit 41 computes a pulsation rate of an air flow rate by dividing the pulsation amplitude acquired as described above by the average air flow rate. In more detail, pulsation rate=(pulsation maximum value−average air flow rate)/average air flow rate×100. As described above, the pulsation rate is a parameter having a correlation with a pulsation amplitude.

The method of acquiring a pulsation rate described above is just an example. That is, the method of acquiring a pulsation rate is not limited to the above. Similarly, the method of acquiring an average air flow rate and a pulsation amplitude is not limited to the above method.

In a manner similar to the above embodiment, a pulsation error does not always increase as a pulsation rate becomes higher but may also decrease as a pulsation rate becomes higher. Similarly, a pulsation error does not always decrease as a pulsation rate becomes lower but may also increase as a pulsation rate becomes lower. Preferably, the pulsation correction value computation unit 50 uses a map in which a pulsation rate and a correction value are associated in a manner similar to the foregoing embodiment so that an accurate correction value can be acquired. As described above, the processing unit 120a acquires a correction value for correcting a pulsation error on the basis of an air flow rate acquired in the intake air flow rate computation unit 30.

The map in which multiple pulsation rates and correction values correlated with the pulsation rates are associated is stored in the processing-unit-side storage unit 122 or the like. Each of the correction values in the map is a value acquired for each pulsation rate in the case of performing an experiment or simulation using a real machine while changing the value of the pulsation rate. In the case where the relation between a pulsation rate and a correction value may be expressed by a function in a manner similar to the foregoing embodiment, the processing unit 120a may compute a correction value by using the function.

The pulsation amplitude and the pulsation rate are correlated values. Consequently, the processing unit 120a enables to produce similar effects by using the pulsation amplitude in place of the pulsation rate as an argument. This point is similar also in the following embodiments.

The processing unit 120a of the second embodiment configured as described above enables to produce effects similar to those of the processing unit 120. The air flow rate measurement system including the processing unit 120a enables to produce effects similar to those of the foregoing embodiment. Further, since a pulsation rate for acquiring a correction value is acquired by the processing unit 120a provided to the air flow meter, information of high-speed sampling data can be acquired from output sampling to the ECU 200. The reason why such a difference occurs is that, although high-speed sampling can be embodied without an influence to the other in the air flow meter processing unit 120a, to increase the speed of the output sampling to the ECU 200, a communication load (ECU computation load) has to be increased. In a state where the high-speed sampling cannot be performed to prevent the load increase, the possibility that the maximum value of pulsation cannot be acquired is high.

### Third Embodiment

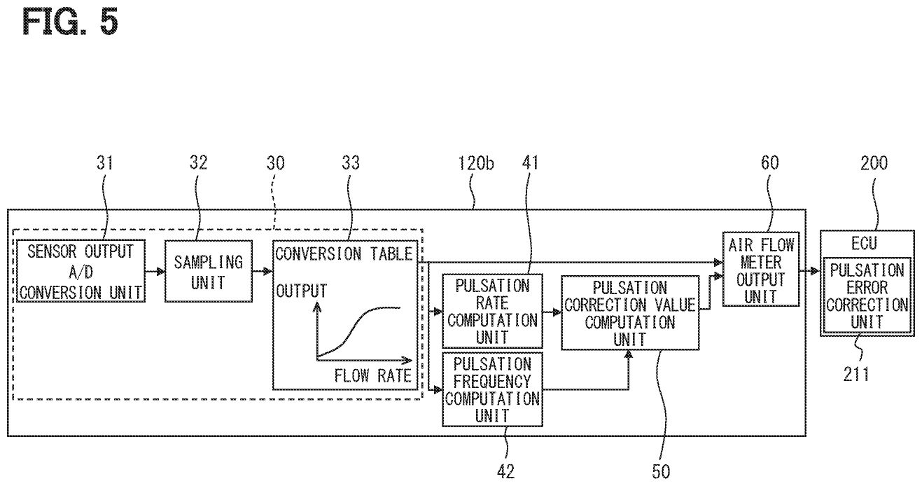

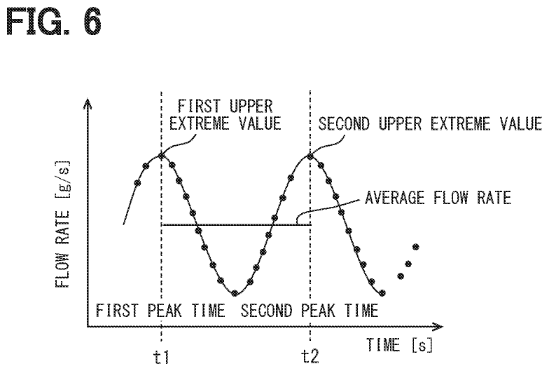

Referring to FIGS. 5 and 6, an air flow meter of the third embodiment will be described. The air flow meter of the third embodiment is different from the second embodiment with respect to the configuration of a processing unit 120b. In more detail, as illustrated in FIG. 6, the processing unit 120b is different from the processing unit 120a with respect to the point that a pulsation frequency computation unit 42 is provided as an example of the argument acquisition unit 40 in addition to the pulsation rate computation unit 41.

In the third embodiment, the different points from the processing unit 120a in the processing unit 120b will be mainly described. In the third embodiment, the same reference numerals are designated to parts similar to those in the second embodiment. Therefore, a component having the same reference numeral as that in the foregoing embodiment may be applied with reference to the foregoing embodiment.

The pulsation frequency computation unit 42 acquires a pulsation frequency including harmonics of the pulsation waveform of an intake as an argument for computing a correction value used for correcting a pulsation error. That is, the processing unit 120b acquires, in the pulsation frequency computation unit 42, the pulsation frequency for computing a correction value on the basis of a detection signal acquired by the intake air flow rate computation unit 30. In other words, in the pulsation frequency computation unit 42, the waveform of a detection signal is captured from the detection signal and a pulsation frequency for computing a correction value, that is, a pulsation frequency for acquiring a pulsation error is acquired. Therefore, the pulsation frequency is a value correlated with a pulsation error. The pulsation frequency computation unit 42 may acquire a pulsation frequency which does not include harmonics of the pulsation waveform in an intake as an argument for computing a correction value used for correction of a pulsation error.

The pulsation frequency computation unit 42 computes a pulsation frequency from multiple sampling values acquired by sampling detection signals. The pulsation frequency computation unit 42 computes a pulsation frequency, for example, by an internal of two peaks in multiple sampling values. In the example, as illustrated in FIG. 6, time of the first peak is set as first peak time t1, and time of the second peak is set as second peak time t2. In this case, pulsation frequency [Hz]=1/(t2−t1). Therefore, the pulsation frequency computation unit 42 can acquire pulsation frequency by computing 1/(t2−t1). The first peak time t1 is time of the first upper-limit value. On the other hand, the second peak time t2 is time of the second upper-limit value.

The pulsation frequency computation unit 42 may compute pulsation frequency by Fourier transform. The pulsation frequency is a frequency of a pulsation waveform in air and may also be referred to as a frequency of an air flow rate. Further, the pulsation frequency may include not only primary wave but also higher-order frequencies such as secondary and third waves.

The pulsation correction value computation unit 50 acquires a pulsation correction value by using a pulsation rate and a pulsation frequency. That is, the processing unit 120b acquires, in the pulsation correction value computation unit 50, a correction value correlated with a pulsation rate and a pulsation frequency by using a pulsation rate acquired by the pulsation rate computation unit 41 and a pulsation frequency acquired by the pulsation frequency computation unit 42. In other words, the processing unit 120b predicts a pulsation error correlated with the pulsation rate and the pulsation frequency and acquires a correction value for eliminating the pulsation error.

The pulsation correction value computation unit 50 acquires a correction value correlated with a pulsation frequency and a pulsation rate by using, for example, a map in which a correction value is associated with a pulsation frequency and a pulsation rate. That is, when a pulsation frequency is acquired by the pulsation frequency computation unit 42 and a pulsation rate is acquired by the pulsation rate computation unit 41, the pulsation correction value computation unit 50 extracts a correction value correlated with the acquired pulsation frequency and the pulsation rate from the map.

In this case, the processing unit 120b includes a two-dimensional map in which multiple combinations of pulsation frequencies and pulsation rates and correction values correlated with the combinations are associated. In the two-dimensional map, for example, pulsation frequency is set in one of axes, pulsation rate is set in the other axis, and each of the correction values is associated with each of the combinations of the pulsation frequencies and the pulsation rates. In other words, in the case of performing an experiment or simulation using a real machine while changing the value of the pulsation frequency and the pulsation rate, each of the multiple correction values is a value acquired by each of combinations of the pulsation frequency and the pulsation rate.

The processing unit 120b may, in the pulsation correction value computation unit 50, predict a pulsation error by using a map in which each of multiple combinations of pulsation frequencies and pulsation rates and a pulsation error correlated with each combination are associated and acquire a correction value from the predicted pulsation error. Each of the pulsation errors in the map is a value acquired for each combination of the pulsation frequency and the pulsation rate in the case of performing an experiment or simulation using a real machine while changing the values of the pulsation frequency and the pulsation rate.

The processing unit 120b of the third embodiment configured as described above enables to produce effects similar to those of the processing unit 120a. The air flow rate measurement system including the processing unit 120b enables to produce effects similar to those of the second embodiment. The processing unit 120b can use frequency (harmonic) information acquired from high-speed sampling data.

Further, a pulsation error is influenced also by a pulsation frequency. Consequently, the processing unit 120b predicts a pulsation error correlated with a pulsation rate and a pulsation frequency and acquires a correction value by using the pulsation error. That is, the processing unit 120b can acquire a correction value depending on a pulsation frequency in addition to a pulsation rate. Therefore, the processing unit 120b can acquire a correction value which can further increase correction accuracy more than a correction value correlated only with a pulsation rate. The ECU 200 can correct a pulsation error with higher accuracy as compared with the case of performing correction by using a correction value corresponding only to a pulsation rate.

The method of acquiring a pulsation frequency is not limited to the above-described example. The pulsation frequency computation unit 42 acquires, for example, detection results of the crank angle sensor 22 and the cam angle sensor 23 from the ECU 200. The pulsation frequency computation unit 42 computes a pulsation frequency on the basis of a detection result acquired from the ECU 200. In this case, the pulsation frequency computation unit 42 may acquire a pulsation frequency by using, for example, a map in which engine rotational speed and pulsation frequency are associated or the like.

Also in such a manner, the processing unit 120b and the air flow rate measurement system including the processing unit 120b enables to produce effects similar to the above. Further, the processing unit 120b acquires a pulsation frequency on the basis of a detection result from the ECU 200, so that the process load can be reduced more than the case of computing a pulsation frequency from multiple sampling values.

### Fourth Embodiment

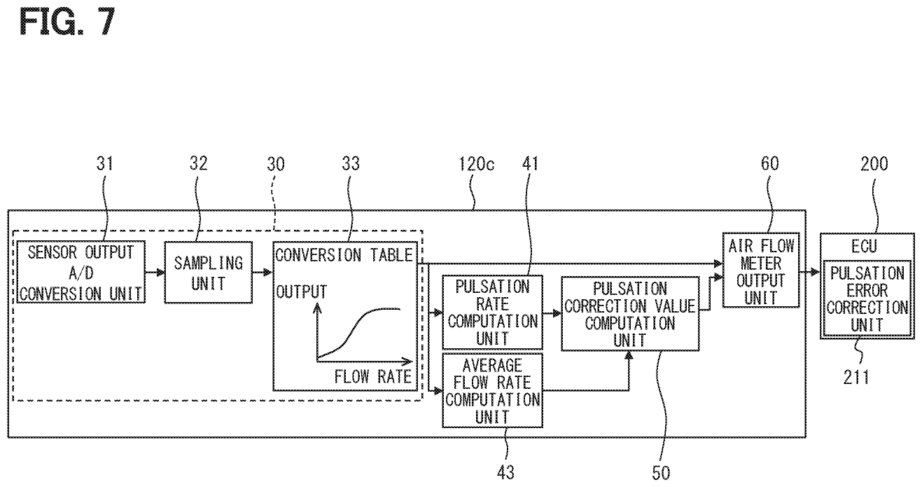

Referring to FIG. 7, an air flow meter of the fourth embodiment will be described. The air flow meter of the fourth embodiment is different from the third embodiment with respect to the configuration of a processing unit 120c. In more detail, as illustrated in FIG. 7, the processing unit 120c is different from the processing unit 120b with respect to the point that an average flow rate computation unit 43 is provided in addition to the pulsation rate computation unit 41 as an example of the argument acquisition unit 40.

In the fourth embodiment, the different points from the processing unit 120b in the processing unit 120c will be mainly described. In the fourth embodiment, the same reference numerals are designated to parts similar to those in the third embodiment. Therefore, a component having the same reference numeral as that in the third embodiment may be applied with reference to the foregoing embodiment.

The average flow rate computation unit 43 acquires an average flow rate of air flow rate as an argument for computing a correction value used for correcting a pulsation error. The average flow rate is the same as the above-described average air flow rate. Therefore, the average flow rate computation unit 43 can acquire an average flow rate by a method similar to that of an average air flow rate.

The pulsation correction value computation unit 50 acquires a pulsation correction value by using a pulsation rate and an average flow rate. That is, the processing unit 120c acquires, in the pulsation correction value computation unit 50, a correction value correlated with a pulsation rate and an average flow rate by using the pulsation rate acquired by the pulsation rate computation unit 41 and the average flow rate acquired by the average flow rate computation unit 43. In other words, the processing unit 120c predicts a pulsation error correlated with a pulsation rate and an average flow rate and acquires a correction value for eliminating the pulsation error.

The pulsation correction value computation unit 50 acquires, for example, a correction value correlated with an average flow rate and a pulsation rate by using a map in which a correction value is associated with an average flow rate and a pulsation rate. That is, when an average flow rate is acquired by the average flow rate computation unit 43 and a pulsation rate is acquired by the pulsation rate computation unit 41, the pulsation correction value computation unit 50 extracts a correction value corrected with the acquired average flow rate and pulsation rate from the map.

In this case, the processing unit 120c includes a two-dimensional map in which multiple combinations of average flow rates and pulsation rates and correction values correlated with the combinations are associated. In the two-dimensional map, for example, average flow rate is set in one of axes, pulsation rate is set in the other axis, and each of the correction values is associated with each of the combinations of the average flow rates and the pulsation rates. In other words, in the case of performing an experiment or simulation using a real machine while changing the value of the average flow rate and the pulsation rate, each of the multiple correction values is a value acquired by each combination of the average flow rate and the pulsation rate.

The processing unit 120c may, in the pulsation correction value computation unit 50, predict a pulsation error by using a map in which each of multiple combinations of average flow rates and pulsation rates and a pulsation error correlated with each combination are associated and acquire a correction value from the predicted pulsation error. Each of the pulsation errors in the map is a value acquired for each combination of the average flow rate and the pulsation rate in the case of performing an experiment or simulation using a real machine while changing the values of the average flow rate and the pulsation rate.

The processing unit 120c of the fourth embodiment configured as described above enables to produce effects similar to those of the processing unit 120b. The air flow rate measurement system including the processing unit 120c enables to produce effects similar to those of the third embodiment.

Further, a pulsation error is influenced also by an average flow rate. Consequently, the processing unit 120c predicts a pulsation error correlated with the pulsation rate and the average flow rate and acquires a correction value by using the pulsation error. That is, the processing unit 120c can acquire a correction value depending on the average flow rate in addition to the pulsation rate. Therefore, the processing unit 120c can acquire a correction value which can further increase correction accuracy more than a correction value correlated with only the pulsation rate. The ECU 200 can correct the pulsation error with higher accuracy as compared with the case of performing correction by using a correction value corresponding only to a pulsation rate.

### Fifth Embodiment

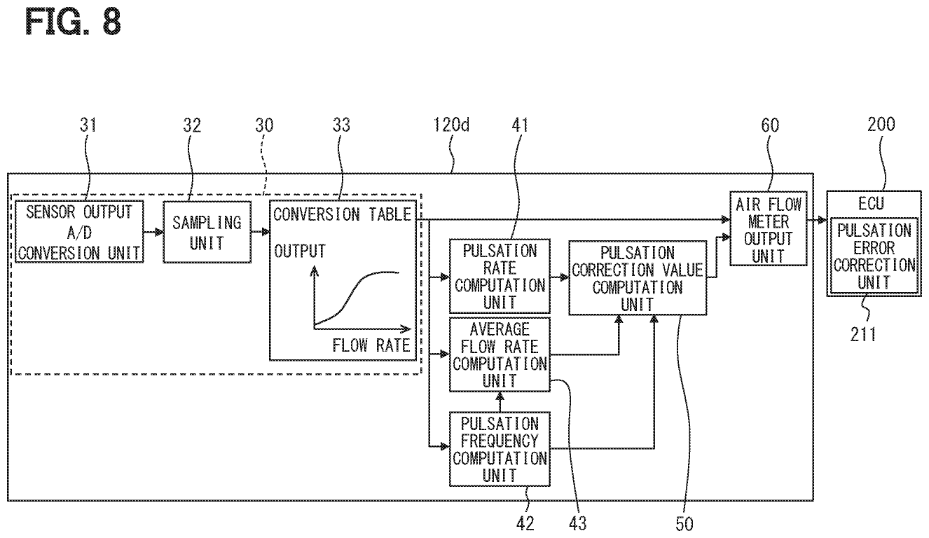

Referring to FIGS. 8 to 11, an air flow meter of the fifth embodiment will be described. The air flow meter of the fifth embodiment is different from the second embodiment with respect to the configuration of a processing unit 120d. In more detail, as illustrated in FIG. 8, the processing unit 120d is different from the processing unit 120a with respect to the point that the pulsation rate computation unit 41, the pulsation frequency computation unit 42, and the average flow rate computation unit 43 are provided as an example of the argument acquisition unit 40. That is, In other words, the processing unit 120d is a combination of the second, third, and fourth embodiments.

In the fifth embodiment, the different points from the processing unit 120a in the processing unit 120d will be mainly described. In the fifth embodiment, the same reference numerals are designated to parts similar to those in the second, third and fourth embodiments. Therefore, a component having the same reference numeral as that in the second, third, and fourth embodiments may be applied with reference to the foregoing embodiments.

The pulsation correction value computation unit 50 acquires a pulsation correction value by using pulsation rate, pulsation frequency, and average flow rate. In other words, the processing unit 120d predicts a pulsation error correlated with the pulsation rate, the pulsation frequency, and the average flow rate and acquires a correction value for eliminating the pulsation error.

In the fifth embodiment, multiple pulsation rates will be described as pulsation rates P1 to n. Similarly, multiple pulsation frequencies will be described as pulsation frequencies F1 to Fn, and multiple average flow rates will be described as average flow rates G1 to Gn. n denotes a natural number. A pulsation error will be described as a pulsation error Err.

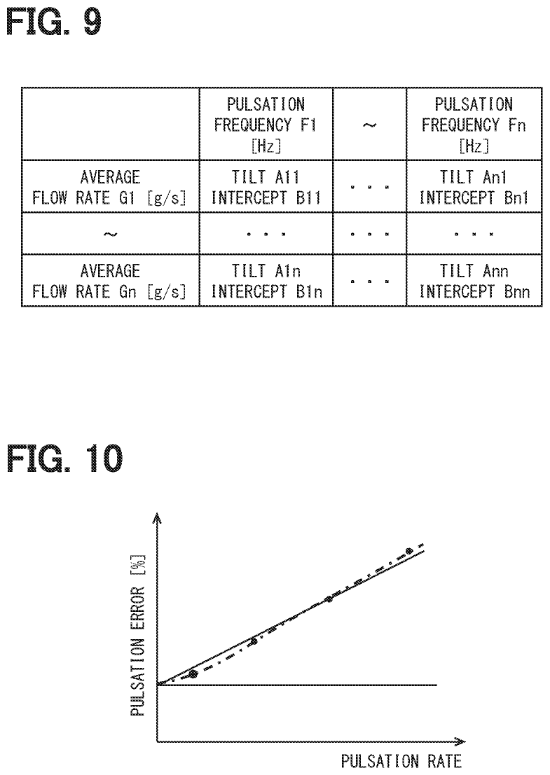

The pulsation correction value computation unit 50 predicts, for example, the pulsation error Err correlated with a pulsation rate, a pulsation frequency, and an average flow rate by using a two-dimensional map illustrated in FIG. 9 and an error prediction formula illustrated in Formula 1 and acquires a correction value from the predicted pulsation error Err. Formula 1 is pulsation error Err=Ann×pulsation rates P1 to n+Bnn.

A correction factor map as illustrated in FIG. 9 is used. In the correction factor map, tilts A11 to Ann and intercepts B11 to Bnn are associated with combinations of the pulsation frequencies F1 to Fn and the average flow rates G1 to Gn. Specifically, in the correction factor map, for example, the average flow rates G1 to Gn are set in one of axes, the pulsation frequencies F1 to Fn are set in the other axis, and each of combinations of the tilts A11 to Ann and the intercepts B11 to Bnn is associated with each of combinations of the average flow rates G1 to Gn and the pulsation frequencies F1 to Fn. Each of the tilts A11 to Ann and the intercepts B11 to Bnn may be acquired by an experiment or simulation using a real machine.

Consequently, In other words, the correction factor map is used for acquiring the tilts A11 to Ann and the intercepts B11 to Bnn at the time of computing the pulsation error Err. In other words, in the correction factor map, a factor in the error prediction formula is associated with each average flow rate G and each pulsation frequency F.

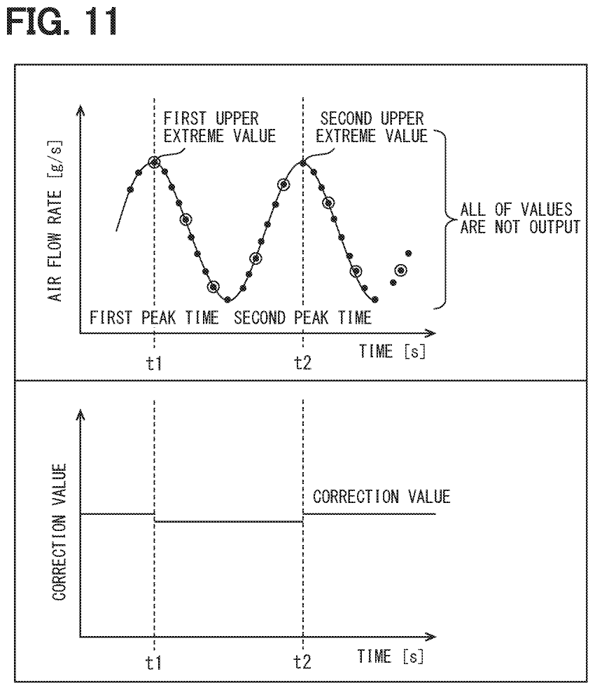

For example, in the case of the pulsation frequency F1 and the average flow rate G1, the pulsation correction value computation unit 50 acquires the tilt A11 and the intercept B11 by using the map. In this case, the relation between the pulsation frequency F1 and the average flow rate G1 may be expressed by the solid line in the graph of FIG. 10. As illustrated, the pulsation correction value computation unit 50 changes the tilt Ann depending on the pulsation rates P1 to n for each of the average flow rates G1 to Gn and the pulsation frequencies F1 to Fn. By computing A11×pulsation rate P1+B11 using the formula 1, the pulsation correction value computation unit 50 can acquire the pulsation error Err. The alternate long and short dash line in FIG. 10 indicates the relation between the pulsation error Err before correction and the pulsation rate, that is, a pulsation characteristic. Although the relation between the pulsation rate and the error is approximated by the linear formula in the fifth embodiment, quadratic or higher-order approximation or broken line approximation with a map may be used. In this case, information such as quadratic or higher-order factor or map points is set for each of the combinations of the pulsation frequencies F1 to Fn and the average flow rates G1 to Gn.

The processing unit 120d acquires correction values in a period from the first peak time t1 to the second peak time t2 in the upper part of FIG. 11 and outputs correction values in the following period as illustrated in the lower part of FIG. 11. That is, the processing unit 120d acquires a correction value on the basis of the information of one pulsation cycle before. The processing unit 120d does not output all of the values indicating the air flow rates illustrated in the upper part of FIG. 11 but output in communication intervals with the ECU. For example, the processing unit 120d does not output all of the values indicating the air flow rates illustrated in the upper part of FIG. 11 but outputs the values surrounded by circles (◯). This point is similar also in the other embodiments.

The processing unit 120d of the fifth embodiment configured as described above enables to produce effects similar to those of the processing unit 120a. The air flow rate measurement system including the processing unit 120d enables to produce effects similar to those of the second embodiment.

Further, the processing unit 120d predicts a pulsation error Err correlated with a pulsation rate, a pulsation frequency, and an average flow rate and acquires a correction value by using the pulsation error Err. Therefore, the processing unit 120d can acquire a correction value which can further increase correction accuracy more than a correction value correlated with only a pulsation rate. The ECU 200 can correct a pulsation error with higher accuracy than the case of performing correction by using a correction value corresponding only to a pulsation rate.

### Sixth Embodiment

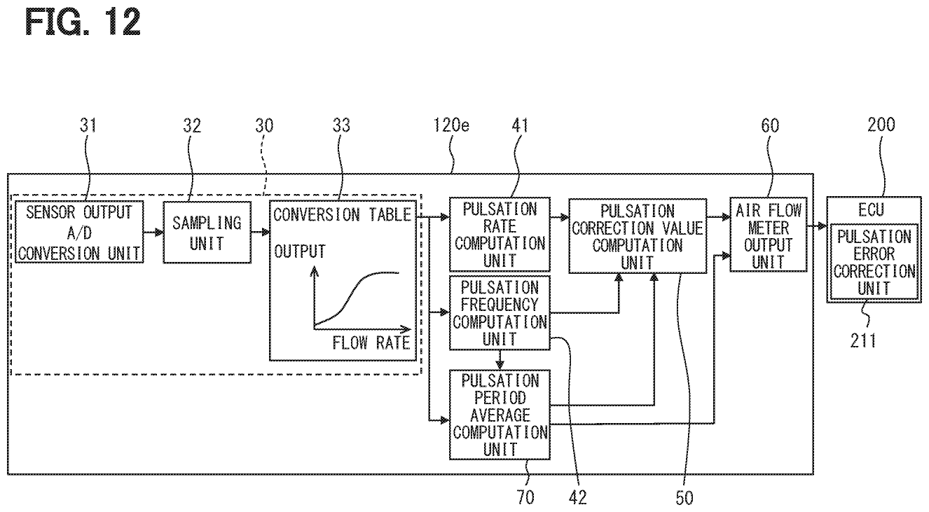

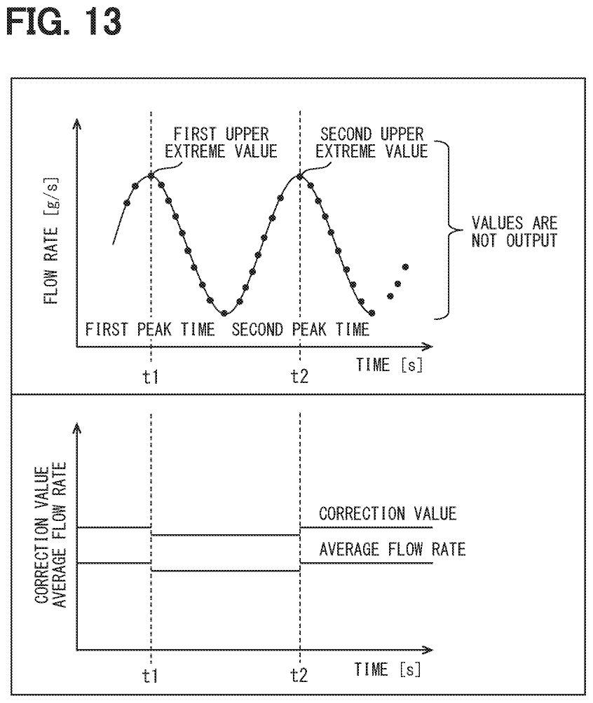

Referring to FIGS. 12 and 13, an air flow meter of the sixth embodiment will be described. The air flow meter of the sixth embodiment is different from the third embodiment with respect to the configuration of a processing unit 120e. In more detail, as illustrated in FIG. 12, the processing unit 120e is different from the processing unit 120b with respect to the point that a pulsation period average computation unit 70 is provided.

In the sixth embodiment, the different points from the processing unit 120b in the processing unit 120e will be mainly described. In the sixth embodiment, the same reference numerals are designated to part similar to those in the third embodiment. Therefore, a component having the same reference numeral as that in the third embodiment may be applied with reference to the foregoing embodiment.

The pulsation period average computation unit 70 corresponds to an average computation unit. The pulsation period average computation unit 70 computes an average value of pulsation periods in air flow rate acquired by the intake air flow rate computation unit 30. That is, the pulsation period average computation unit 70 acquires an average value for each pulsation period of the air flow rate before correction on the basis of the air flow rate before correction which is converted by the conversion table 33 and the pulsation frequency acquired by the pulsation frequency computation unit 42.

The air flow meter output unit 60 outputs an average value acquired by the pulsation period average computation unit 70 as an air flow rate. That is, as illustrated in FIG. 13, the air flow meter output unit 60 outputs an average value and a correction value.

The processing unit 120e of the sixth embodiment configured as described above enables to produce effects similar to those of the processing unit 120b. The air flow rate measurement system including the processing unit 120e enables to produce effects similar to those of the third embodiment.

### Seventh Embodiment

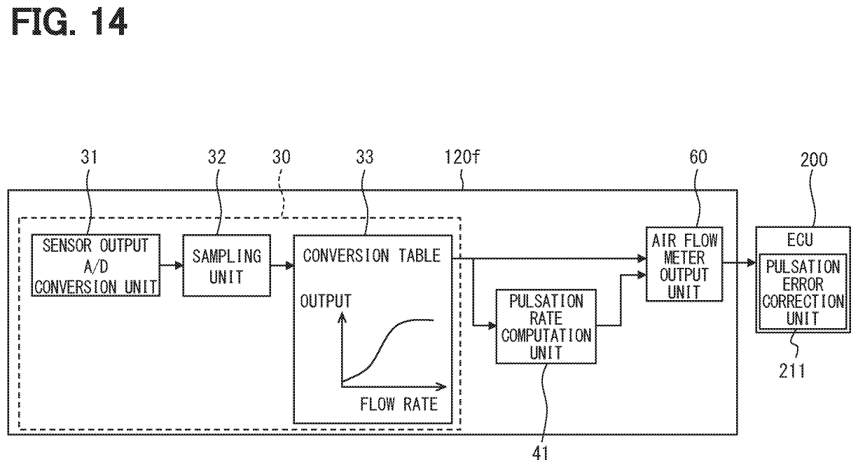

Referring to FIG. 14, an air flow meter of the seventh embodiment will be described. The air flow meter of the seventh embodiment is different from the second embodiment with respect to the configuration of a processing unit 120f. In more detail, as illustrated in FIG. 14, the processing unit 120f is different from the processing unit 120a with respect to the point that the pulsation correction value computation unit 50 is not provided.

In the seventh embodiment, the different points from the processing unit 120a in the processing unit 120f will be mainly described. In the seventh embodiment, the same reference numerals are designated to parts similar to those in the second embodiment. Therefore, the component having the same reference numeral as that in the second embodiment may be applied with reference to the foregoing embodiment.

As described above, the processing unit 120f does not have the pulsation correction value computation unit 50. Consequently, the air flow meter output unit 60 outputs, as pulsation correction information, a pulsation rate which is an argument to the ECU. That is, the processing unit 120f outputs, by the air flow meter output unit 60, an air flow rate before correction converted by the conversion table 33 and a pulsation rate as pulsation correction information acquired by the pulsation rate computation unit 41 to the ECU 200 via a signal line.

In this case, the ECU 200 acquires a correction value on the basis of the pulsation rate output from the processing unit 120f in a manner similar to the pulsation correction value computation unit 50. That is, In other words, the ECU 200 has a function similar to that of the pulsation correction value computation unit 50.

The processing unit 120f of the seventh embodiment configured as described above enables to produce effects similar to those of the processing unit 120a. The air flow rate measurement system including the processing unit 120f enables to produce effects similar to those of the foregoing embodiment. Further, since it is unnecessary to acquire a correction value, the processing unit 120f can reduce the process load more than the processing unit 120a.

### Eighth Embodiment

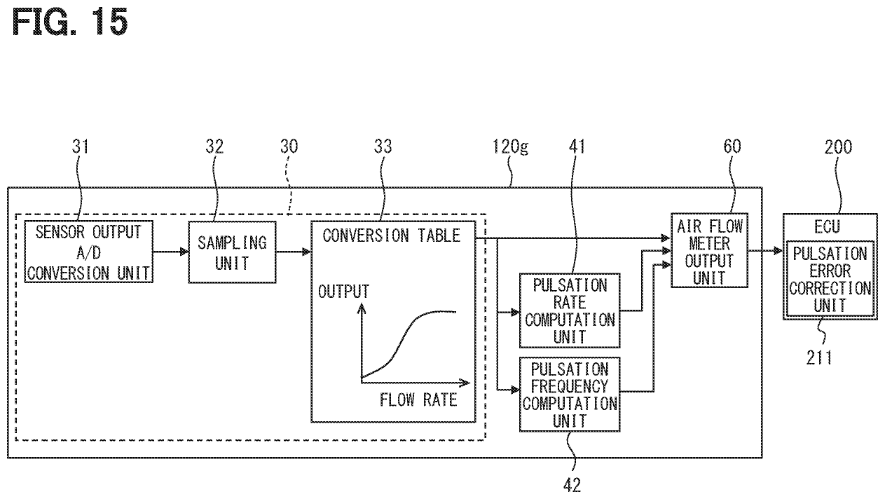

Referring to FIG. 15, an air flow meter of the eighth embodiment will be described. An air flow meter of the eighth embodiment is different from the third embodiment with respect to the configuration of a processing unit 120g. In more detail, as illustrated in FIG. 15, the processing unit 120g is different from the processing unit 120b with respect to the point that the pulsation correction value computation unit 50 is not provided.

In the eighth embodiment, the different points from the processing unit 120b in the processing unit 120g will be mainly described. In the eighth embodiment, the same reference numerals are designated to parts similar to those in the third embodiment. Therefore, a component having the same reference numeral as that in the third embodiment may be applied with reference to the foregoing embodiment.

As described above, the processing unit 120g does not have the pulsation correction value computation unit 50. Consequently, the air flow meter output unit 60 outputs, as pulsation correction information, a pulsation rate which is an argument and a pulsation frequency to the ECU. That is, the processing unit 120g outputs, by the air flow meter output unit 60, an air flow rate before correction converted by the conversion table 33, a pulsation rate acquired by the pulsation rate computation unit 41, and a pulsation frequency acquired by the pulsation frequency computation unit 42 to the ECU 200 via a signal line. Since the pulsation frequency is acquired from information sampled at high speed in the air flow meter, a harmonic component can also be output to the ECU 200.

In this case, the ECU 200 acquires a correction value on the basis of a pulsation rate and a pulsation frequency output from the processing unit 120g in a manner similar to the pulsation correction value computation unit 50. That is, In other words, the ECU 200 has a function similar to that of the pulsation correction value computation unit 50.

The processing unit 120g of the eighth embodiment configured as described above enables to produce effects similar to those of the processing unit 120b. The air flow rate measurement system including the processing unit 120g enables to produce effects similar to those of the foregoing embodiment. Further, since it is unnecessary to acquire a correction value, the processing unit 120g can reduce the process load more than the processing unit 120b.

### Ninth Embodiment

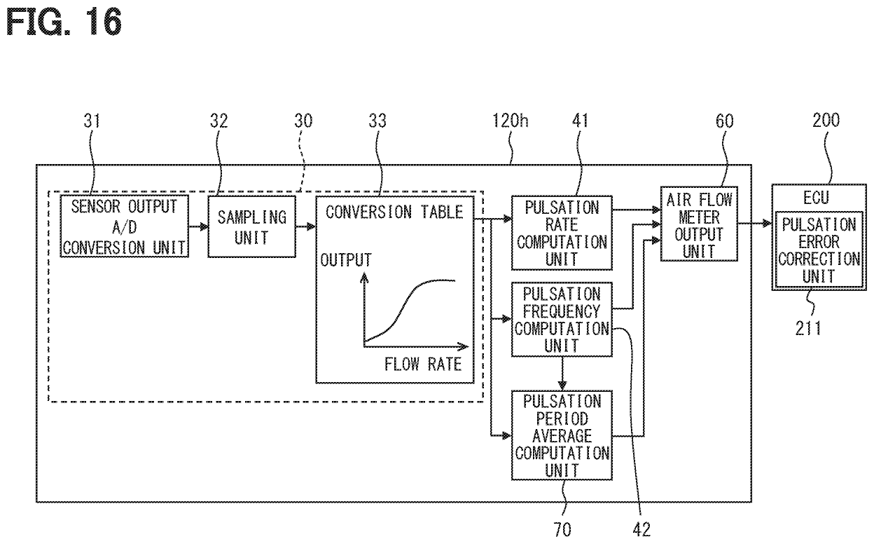

Referring to FIG. 16, an air flow meter of the ninth embodiment will be described. The air flow meter of the ninth embodiment is different from the sixth embodiment with respect to the configuration of a processing unit 120h. In more detail, as illustrated in FIG. 16, the processing unit 120h is different from the processing unit 120e with respect to the point that the pulsation correction value computation unit 50 is not provided.

In the ninth embodiment, the different points from the processing unit 120e in the processing unit 120h will be mainly described. In the eighth embodiment, the same reference numerals are designated to parts similar to those in the sixth embodiment. Therefore, a component having the same reference numeral as that in the sixth embodiment may be applied with reference to the foregoing embodiment.

As described above, the processing unit 120h does not have the pulsation correction value computation unit 50. Consequently, the air flow meter output unit 60 outputs, as pulsation correction information, a pulsation rate which is an argument and a pulsation frequency to the ECU. That is, the processing unit 120h outputs, by the air flow meter output unit 60, an average value of pulsation periods of an air flow rate before correction acquired by the pulsation period average computation unit 70, a pulsation rate acquired by the pulsation rate computation unit 41, and a pulsation frequency acquired by the pulsation frequency computation unit 42 to the ECU 200 via a signal line.

In this case, the ECU 200 acquires a correction value on the basis of the pulsation rate and the pulsation frequency output from the processing unit 120h in a manner similar to the pulsation correction value computation unit 50. That is, In other words, the ECU 200 has a function similar to that of the pulsation correction value computation unit 50.

The processing unit 120h of the ninth embodiment configured as described above enables to produce effects similar to those of the processing unit 120e. The air flow rate measurement system including the processing unit 120h enables to produce effects similar to those of the foregoing embodiment. Further, since it is unnecessary to acquire a correction value, the processing unit 120h can reduce the process load more than the processing unit 120e.

The configuration that the pulsation correction value computation unit 50 is not provided may be applied also to the fourth and fifth embodiments. In this case, in a manner similar to the above, the process load of the processing unit can be reduced.

### Tenth Embodiment

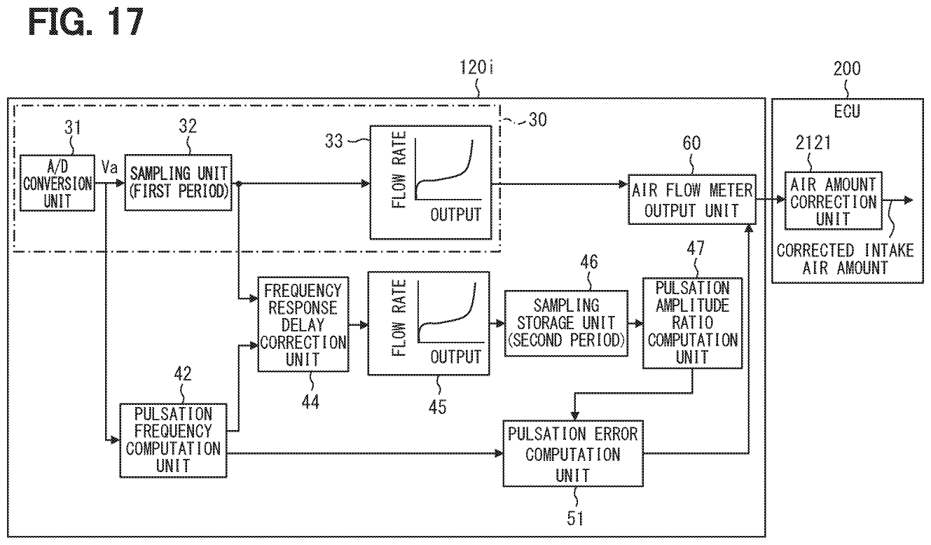

Referring to FIG. 17, an air flow meter of the tenth embodiment will be described. The air flow meter of the tenth embodiment is different from the second embodiment with respect to the configuration of a processing unit 120i. In more detail, as illustrated in FIG. 17, the processing unit 120i includes the pulsation frequency computation unit 42 in place of the pulsation rate computation unit 41. Further, the processing unit 120i includes a frequency response delay correction unit 44, a conversion table 45, a sampling storage unit 46, a pulsation amplitude ratio computation unit 47, and a pulsation error computation unit 51.

The processing unit 120i uses an output signal from the A/D convestion unit 31 as an input and refers to an A/D conversion value by using the sampling unit 32 at a sampling timing (for example, 2 ms) as a first period. The A/D convestion unit 31 is a value attenuated by a frequency characteristic such as a sensor response delay. Consequently, the processing unit 120i resets the value to a value before attenuation by using the frequency response delay correction unit 44. For this operation, the processing unit 120i computes the present pulsation frequency by using the pulsation frequency computation unit 42, predicts an attenuation amount of the waveform from the pulsation frequency, and restores the waveform to the value before the attenuation by the frequency response delay correction unit 44.

The conversion table 45 has a function similar to that of the conversion table 33. Different from the conversion table 33, the conversion table 45 converts a value output from the frequency response delay correction unit 44 to an air flow rate.

The sampling storage unit 46 stores and holds an air flow rate for a second period (which is longer than the first period and, for example, 20 ms) using an output signal from the conversion table 45 as an input. The pulsation amplitude ratio computation unit 47 computes a pulsation amplitude ratio from the maximum air amount, the minimum air amount, and an average air amount in the second period.

The pulsation error computation unit 51 acquires a correction value using a pulsation frequency and a pulsation amplitude ratio as arguments. In a manner similar to the pulsation correction value computation unit 50, the pulsation error computation unit 51 predicts a pulsation error correlated with a pulsation frequency and a pulsation amplitude ratio by using a map or the like and acquires a correction value for eliminating the pulsation error.

The ECU 200 includes an air amount correction unit 211a corresponding to the pulsation error correction unit 211.

The processing unit 120i of the tenth embodiment configured as described above enables to produce effects similar to those of the processing unit 120a. The air flow rate measurement system including the processing unit 120i enables to produce effects similar to those of the second embodiment.

Further, the processing unit 120i predicts a pulsation error correlated with a pulsation frequency and a pulsation amplitude ratio and acquires a correction value by using the pulsation error. Therefore, the processing unit 120i can acquire a correction value which can further increase correction accuracy more than a correction value correlated with only a pulsation rate. The ECU 200 can correct a pulsation error with higher accuracy as compared with the case of performing correction by using a correction value corresponding only to a pulsation rate.

### Eleventh Embodiment

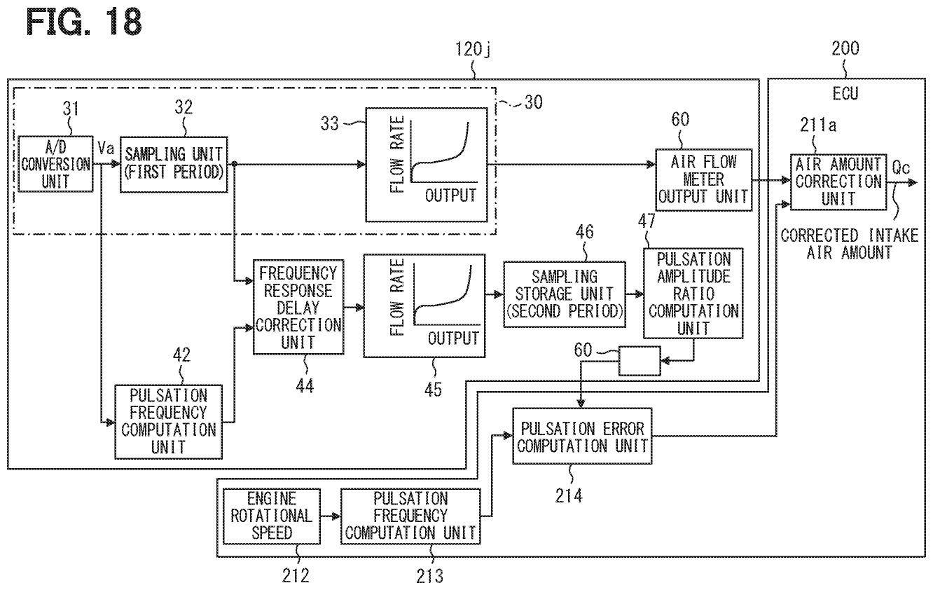

Referring to FIG. 18, an air flow meter of the eleventh embodiment will be described. The air flow meter of the eleventh embodiment is different from the tenth embodiment with respect to the configuration of a processing unit 120j. In more detail, as illustrated in FIG. 18, the processing unit 120j is different from the processing unit 120i with respect to the point that the pulsation error computation unit 51 is not provided.

The air flow meter output unit 60 outputs, as pulsation correction information, a pulsation amplitude ratio which is an argument to the ECU 200. That is, the processing unit 120j outputs, by the air flow meter output unit 60, an air flow rate before correction converted by the conversion table 33 and a pulsation amplitude ratio as pulsation correction information acquired by the pulsation amplitude ratio computation unit 47 to the ECU 200 via a signal line.

On the other hand, the ECU 200 includes, in addition to the air amount correction unit 211a, an engine rotational speed acquisition unit 212, a pulsation frequency computation unit 213, and a pulsation error computation unit 214.

The engine rotational speed acquisition unit 212 acquires engine rotational speed as described above. The pulsation frequency computation unit 213 computes pulsation frequency on the basis of the engine rotational speed acquired by the engine rotational speed acquisition unit 212. The pulsation error computation unit 214 has a function similar to that of the pulsation error computation unit 51.

The processing unit 120j of the eleventh embodiment configured as described above enables to produce effects similar to those of the processing unit 120i. The air flow rate measurement system including the processing unit 120j enables to produce effects similar to those of the tenth embodiment. Further, the processing unit 120j can reduce the process load more than the processing unit 120i as it is unnecessary to acquire a correction value.

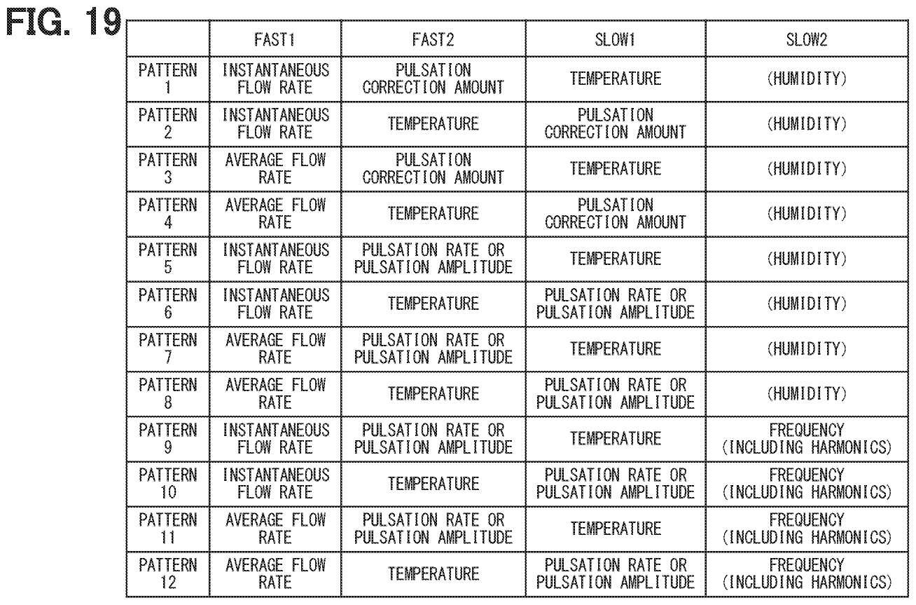

An output pattern in the air flow meter output unit 60 is not limited to that described in the first to eleventh embodiments. Multiple output patterns as illustrated in FIG. 19 may be considered as those of the air flow meter output unit 60. That is, the air flow meter output unit 60 outputs information as illustrated in FIG. 19 in each of FAST1 channel, FAST2 channel, SLOW1 channel, and SLOW2 channel.

Instantaneous flow rate in FIG. 19 corresponds to air flow rate. The average flow rate corresponds to an average value of internal computation values in a pulsation period or an average value of internal computation values within a period of communication with the ECU 200. The temperature in FIG. 19 corresponds to temperature of intake. The humidity in FIG. 19 is humidity of intake.

Although the present disclosure has been described in accordance with the embodiments, it is understood that the present disclosure is not limited to the embodiments and structures. The present disclosure includes various modification examples and also modifications within the range of equivalency. In addition, various combinations and modes, further, other combinations and modes including only one element or more or less than that are within the range of the present disclosure and the concept range.

The above-described air flow rate measuring device measures an air flow rate on the basis of an output signal of the sensing unit 110 placed in the environment where air flows and outputs the air flow rate to an electronic device. The air flow rate measuring device includes: a flow rate acquisition unit 30 acquiring an air flow rate on the basis of an output signal; correction information acquisition units 40 and 50 acquiring pulsation correction information for correcting a pulsation error as an error of the air flow rate by pulsation of air on the basis of the air flow rate acquired by the flow rate acquisition unit; and an output unit 60 outputting pulsation correction information in addition to the air flow rate to the electronic device.

As described above, the output unit 60 outputs pulsation correction information for correcting a pulsation error in addition to the air flow rate to the electronic device. Therefore, in the configuration, the electronic device does not have to sample air flow rate at speed higher than that in the case where the pulsation correction is not performed in order to correct the pulsation error. Consequently, the configuration can suppress increase in the communication load between the electronic device and the air flow rate measuring device to correct a pulsation error.

The air flow rate measuring system includes the air flow rate measuring device and an electronic device. The electronic device includes the pulsation error correction unit 211 acquiring an air flow rate and pulsation correction information output from the air flow rate measuring device and correcting the air flow rate on the basis of the pulsation correction information.

As described above, the configuration enables to produce effects similar to the above. Further, the electronic device acquires pulsation correction information output from the air flow rate measuring device, so that it is unnecessary to acquire a pulsation correction state on the basis of the air flow rate. Consequently, the electronic device can correct a pulsation error while suppressing increase in process load.

1. An air flow rate measuring device configured to measure an air flow rate based on an output signal of a sensing unit, which is placed in an environment where air flows, and to output the air flow rate to an electronic device, the air flow rate measuring device comprising:
a flow rate acquisition unit configured to acquire the air flow rate based on the output signal;
a correction information acquisition unit configured to acquire pulsation correction information for correcting a pulsation error, which is an error of the air flow rate caused by pulsation of air, based on the air flow rate acquired by the flow rate acquisition unit; and
an output unit configured to output the pulsation correction information in addition to the air flow rate to the electronic device.

2. The air flow rate measuring device according to claim 1, wherein
the correction information acquisition unit is configured to acquire a pulsation rate or a pulsation amplitude in a pulsation waveform of air as an argument for computing a correction value, which is used for correcting the pulsation error, based on the output signal to acquire the pulsation correction information.

3. The air flow rate measuring device according to claim 2, wherein
the correction information acquisition unit is configured to further acquire a pulsation frequency of the pulsation waveform in air as the argument for computing the correction value, which is used for correcting the pulsation error, based on the output signal to acquire the pulsation correction information.

4. The air flow rate measuring device according to claim 2, wherein
the correction information acquisition unit is configured to further acquire an average flow rate of the air flow rate as the argument for computing the correction value, which is used for correcting the pulsation error, based on the output signal to acquire the pulsation correction information.

5. The air flow rate measuring device according to claim 2, wherein
the correction information acquisition unit is configured to acquire the correction value by using the argument as the pulsation correction information, and
the output unit is configured to output the correction value as the pulsation correction information to the electronic device.

6. The air flow rate measuring device according to claim 2, wherein
the output unit is configured to output the argument as the pulsation correction information to the electronic device.

7. The air flow rate measuring device according to claim 1, further comprising:
an average computation unit configured to compute an average value of pulsation periods of the air flow rate acquired by the flow rate acquisition unit, wherein
the output unit is configured to output the average value computed by the average computation unit as the air flow rate.

8. An air flow rate measuring system comprising:
the air flow rate measuring device according to claim 1; and
the electronic device, wherein
the electronic device includes a pulsation error correction unit configured
to acquire the air flow rate and the pulsation correction information output from the air flow rate measuring device and
to correct the air flow rate based on the pulsation correction information.

9. An air flow rate measuring device comprising:
a sensor placed in an environment where air flows and configured to output an output signal;
a processor configured
to acquire an air flow rate based on the output signal from the sensor and
to acquire pulsation correction information based on the air flow rate as acquired, the pulsation correction information being for correcting a pulsation error, which is an error of the air flow rate caused by pulsation of air; and
an output circuit configured to output both the pulsation correction information and the air flow rate to an external electronic device outside of the air flow rate measuring device.

10. A method for measuring an air flow rate of air, the method comprising:
acquiring, by using a sensor placed in an environment where air flows, an output signal that correlates to the airflow rate of air;
acquiring, by using a processor, an air flow rate based on the output signal from the sensor;
acquiring, by using the processor, pulsation correction information based on the air flow rate as acquired, the pulsation correction information being for correcting a pulsation error, which is an error of the air flow rate caused by pulsation of air; and
outputting, by using an output circuit, both the pulsation correction information and the air flow rate to an external electronic device outside of the air flow rate measuring device.
